(19) United States
(12) Patent Application Publication
(10) Pub. No.: US 2023/0348228 A1
(43) Pub. Date: Nov. 2, 2023

(54) SAFETY DEVICE FOR CONTROLLING SAFETY-RELEVANT UCM AND UDM FUNCTIONS IN AN ELEVATOR SYSTEM

(71) Applicant: Inventio AG, Hergiswil (CH)

(72) Inventor: Claudio Colombano, Beckenried (CH)

(21) Appl. No.: 18/044,792

(22) PCT Filed: Sep. 13, 2021
(86) PCT No.: PCT/EP2021/075087

§ 371 Date: Mar. 10, 2023

(30) Foreign Application Priority Data
Sep. 17, 2020 (EP) 20196605.8

(51) Int. Cl. B66B 5/00; B66B 13/14

(52) U.S. Cl. CPC B66B 5/0031; B66B 13/143

(57) ABSTRACT

A safety device for controlling safety-relevant functions in an elevator system is configured, on the basis of input signals from at least one first component of the elevator system which provides information regarding current conditions within the elevator system, for example a current position and speed of a car, not only to control at least one second component, such as a brake, of the elevator system such that an unintended travel movement of the car is prevented. The safety device also controls at least one third component, such as a door drive, of the elevator system such that an unintended movement of a car door is prevented. In the safety device, both a UCM (unintended car movement) function and a UDM (unintended door movement) function are thus implemented.

### FIELD

The present invention relates to a safety device for controlling safety-relevant functions in an elevator system and to a correspondingly equipped elevator system.

### BACKGROUND

In elevator systems, persons can be transported vertically between different floors of a building in a car. Here, very high safety requirements must be met. For example, it must be ensured that the car, which is sometimes also referred to as an elevator cab, is not unintentionally moved while its doors are not correctly closed. In addition, it should be ensured that doors of the car are not unintentionally opened or closed.

EP 2 583 928 A1, EP 2 477 925 A1 and CN 109650210 A describe devices or methods by means of which unintended travel movements of a car in an elevator system can be prevented.

Among other things, there may be a need for a safety device and an elevator system equipped therewith, by means of which, on the one hand, safe operation of the elevator system can be ensured and which, on the other hand, are simple, reliable and/or cost-effective to install.

### SUMMARY

Such a need can be met by the safety device and the elevator system according to the advantageous embodiments defined in the following description.

According to a first aspect of the invention, a safety device for controlling safety-relevant functions in an elevator system is proposed. In this case, the safety device is configured, on the basis of input signals from at least one first component of the elevator system which provide information regarding current conditions within the elevator system, to control at least one second component of the elevator system in such a way that an unintended travel movement of a car of the elevator system is prevented, and to control at least one third component of the elevator system in such a way that an unintended movement of a car door is prevented.

According to a second aspect of the invention, an elevator system is proposed, which comprises at least the following:
at least one first component, which is configured to supply input signals which provide information regarding current conditions within the elevator system,
at least one second component, which is configured to prevent an unintended travel movement of a car of the elevator system in response to receiving a first control signal,
at least one third component, which, in response to receiving a second control signal, is configured to prevent an unintended movement of a car door of the car of the elevator system, and
a safety device according to the first aspect of the invention for controlling the at least one second component and the at least one third component in each case on the basis of the input signals from the at least one first component.

Possible features and advantages of embodiments of the invention can be considered, inter alia and without limiting the invention, to be based upon the concepts and findings described below.

In elevator systems, a car door is used to selectively release or block access into the car by opening or closing one or more door leaves of the car door. In general, the car door has for this purpose an actuator, such as an electric motor, to enable it to move the door leaves. This actuator is typically controlled by a very simple, “dumb” actuator controller. For example, when an activation signal is received which indicates that the car door is to be opened or closed, the actuator controller controls an electric current supplied to the actuator such that the door leaves are moved to an open configuration or to a closed configuration with a suitable force and/or speed. Here, the activation signal is usually generated by an elevator controller which monitors the operation of the entire elevator system and via activation signals controls individual components of the elevator system accordingly. For example, the elevator controller can recognize, on the basis of information available thereto, that the car has been moved to a desired floor and stopped there, so that the activation signal can then be output, according to which the car door can be opened in order to allow passengers to enter the car.

In order to maximize safety during operation of the elevator system, an additional control instance is provided in many elevator systems in order to be able to prevent unintended movements of the car door. Such unintended movements are often also referred to as UDM (unintended door movements). Unintended door movements can be caused, for example, when the elevator controller generates activation signals due to malfunctions or due to erroneous available information regarding a current state of the elevator, even though opening of the car door, for example, should not be permissible for the actual current state of the elevator system because the car is currently moving, for example.

A device which is used to protect against unintended door movements (referred to in the following as a UDM function) can, for example, analyze an activation signal transmitted to the actuator controller of the car door with regard to the plausibility thereof. In this case, for example on the basis of other available information, it is possible to monitor whether an opening or closing of the car door appears to be permissible in an instantaneous operating situation and whether an activation signal to be transmitted to the actuator controller of the car door should actually be forwarded to this actuator controller or whether this activation signal should be filtered out due to lack of plausibility.

Conventionally, a device implementing the UDM function (referred to in the following as a UDM device) is typically connected as a separate assembly between on the one hand the device which generates the activation signal, i.e., for example, the elevator controller, and on the other hand the actuator controller ultimately receiving the activation signal. Accordingly, the UDM device can block forwarding of an activation signal if necessary, i.e., in particular when the activation signal has been recognized as not sufficiently plausible.

For the plausibility check, the UDM device can receive, for example, signals or information from sensors or other components of the elevator system which enable a conclusion to be drawn regarding the current permissibility of a door movement of the car door. For example, the UDM device can detect, via switches or other sensors arranged suitably along the travel path of the car, when the car is located at the level of a floor and stops there. Optionally, the UDM device can also detect, via further switches or other sensors, when the car is within a so-called door zone, i.e., is within an acceptable height tolerance already very close to a desired target height adjacent to the floor. In the context of the plausibility check, it can then be checked whether the car is currently stopped at a floor, so that the car door may be opened, or is close to such a target position at least within the height tolerance, so that an opening of the car door may already be initiated at the floor shortly before reaching the target position.

However, while implementing the UDM function in an elevator system is desirable in most applications, it has been recognized that the manner in which a UDM device to be used for this purpose has previously been implemented may lead to disadvantages. For example, providing a separate UDM device typically results in increased cost and effort for providing and installing this device. The intermediate connection of the UDM device between, for example, the elevator controller and the actuator controller and possibly an arrangement of the UDM device remotely from the other components can also cause extended signal transmission times, i.e., a time period between generating an activation signal in the elevator controller and receiving this activation signal in the actuator controller may become longer. This can result, for example, in the car door being opened late when the car approaches a target position or being closed too late when moving away from the target position. In addition, an additional expenditure on cables and installation effort for laying same can ensue for a connection of the UDM device. Furthermore, it has also already been observed that operators or users of the elevator system may misunderstand the existence of a separate UDM device, the exact function of which they may not be able to understand, and may be afraid that the elevator system could be inherently unsafe and therefore would require an additional safety device.

The safety device proposed herein addresses at least some of these disadvantages. In this regard, it is proposed that the implementation of the UDM function be integrated not in a separate device but in a device provided in any case in any elevator system for other purposes.

In particular, it is proposed to integrate the UDM function into a device which is used in elevator systems to reliably prevent unintended travel movements of the car. For example, during operation of an elevator system, it must always be ensured that the car is moved exclusively when this is permissible without danger. For example, the car may on no account be moved while the car door or a shaft door is not yet correctly closed and locked, in particular in order to ensure that a person passing through such a door is not injured by the moving car. The prevention of unintended travel movements of the car is also referred to as a UCM (unintended car movement) function. Regulations such as the European standard EN 81:20 or US standard A17 stipulate that the UCM function must mandatorily be implemented in elevator systems in order to prevent serious accidents due to unintended car movements. Accordingly, each elevator system has a UCM device.

Such a UCM device is configured to receive suitable input signals, for example from sensors, switches or other components of the elevator system, the input signals providing information regarding current conditions within the elevator system. For example, the input signals can indicate where the car is currently located, whether it is currently being moved or is stopped at a floor, how fast and in which direction the car is moving, whether a car door and/or shaft doors are open or closed or are currently opening or closing, etc. In particular, the input signals can provide all information which must be monitored in accordance with the applicable regulations in order to reliably prevent an unintended travel movement of the car.

The UCM device is further configured to control one or more other components of the elevator system, taking into account the input signals received thereby, in such a way that the unintended travel movement of the car is ultimately prevented. For example, the UCM device can control a brake which is designed to brake the car in order to prevent in this way an unintended travel movement of the car. In addition, the UCM device can control a drive unit which is designed to move the car along a travel path, wherein the UCM device can interrupt, for example, a power supply to the drive unit when an unintended travel movement is detected.

The UCM device is typically designed as a very safe assembly. For example, the UCM device is usually designed such that it meets high safety requirements such as safety level SIL3 (safety integrity level 3). For this purpose, monitoring measures and/or redundancies can be provided in the UCM device by means of which malfunctions can be detected or prevented and even failures can be prevented.

It is now proposed to integrate a device for implementing the UDM function into the UCM device that is to be provided in the elevator system anyway. In other words, a single safety device is to be configured to enable performance of not only the UCM function but also the UDM function.

In this case, use is advantageously made of the fact that that the signals and data typically required by a UCM device, which receives these signals from sensors or other components of the elevator system in order to be able to implement the UCM function, generally contain enough information regarding the conditions currently prevailing in the elevator system that the UDM function can also be implemented using them. In other words, the kinematic information regarding the current location and the current speed of the car received as input signals from the UCM device can, for example, also be used for implementing the UDM function, since it is possible, for example, to determine therefrom whether the car is currently at a stopping position or in a door zone close to the stopping position. In addition, it is possible to determine from the information mentioned, in particular from the current speed and acceleration of the car, whether the car is stopped at a floor position located in the vicinity or is moving past this floor position. The information mentioned is generally necessary and sufficient to determine whether the car door may be safely opened, and can therefore be used to implement the UDM function in order, for example, to check for plausibility an activation signal to be transmitted to the actuator controller and to filter out this signal if necessary in the event of lack of plausibility.

According to one embodiment, the safety device comprises at least the following assemblies:
a signal input interface for receiving the input signals from the at least one first component of the elevator system,
a signal processing unit for processing the input signals and generating first and second control signals based in each case on the input signals, and
a control unit for controlling the at least one second component of the elevator system on the basis of the generated first control signals and the at least one third component of the elevator system on the basis of the generated second control signals.

The signal input interface can receive the input signals from the first component. For this purpose, the signal input interface can have electrical connections, for example, via which it can be wired to the first component. Alternatively, the signal input interface can communicate wirelessly with the first component and, for this purpose, transmit radio signals to the first component and/or receive them therefrom. The signal processing unit can process the input signals received via the signal input interface in order to generate the first and second control signals on the basis thereof. These control signals can then be used by the control unit to implement not only the UDM function but also the UCM function. In this case, the control unit can transmit the first control signals to the second component, by means of which the UCM function is carried out. If necessary, the control unit or the safety device can have a first signal output interface for this purpose. In addition, the control unit can transmit the second control signals to the third component, by means of which the UDM function is carried out. For this purpose, the control unit or the safety device can have a second signal output interface.

According to one embodiment, the at least one first component supplies input signals which indicate a current position and a current speed of the car of the elevator system.

For this purpose, the elevator system can have, as at least one first component, for example one or more sensors, by means of which the current position at which the car is located within the elevator system can be determined. For this purpose, a plurality of markings can for example be provided in the elevator system which encode the position of the marking and which can be read, for example, by a sensor mounted on the car. For example, a magnetizable strip can be arranged along the travel path of the car and position information can be magnetically stored on the strip. However, the position of the car can also be determined in various other ways, for example by presence sensors arranged along the travel path, light barriers, a local or global positioning system (GPS), air-pressure measuring sensors for measuring a height-dependent air pressure, or the like.

By analyzing the change in the current position of the car, it is then also possible to deduce its current speed. Alternatively or additionally, the elevator system can have a device with which a speed, in particular an overspeed, of the car can be detected.

According to a specific embodiment, the at least one first component can supply input signals which indicate a current position and a current speed of the car of the elevator system for each possible position of the car along a travel path of the car and for each point in time during operation of the elevator system.

In other words, the at least one first component can supply information regarding the current location and the current speed of the car not only for certain operating situations in which the car is located, for example, at a floor position or within a door zone in the vicinity of a floor position. Instead, the first component should preferably be able to determine the current position and speed of the car for each possible operating situation to be assumed by the elevator system, i.e., for each possible position of the car along a permissible travel path. It should preferably be possible to provide this information on the basis of the input signals from the first component for each point in time during operation of the elevator system.

According to one embodiment, the at least one second component comprises a brake which is configured to brake or prevent a travel movement of the car.

For example, the second component can be a brake, in particular an emergency brake, which is attached to the car or which can interact with a suspension means moving the car and by means of which the car can be quickly and efficiently braked in a travel movement or prevented from making a travel movement. By allowing such a brake to be activated by transmitting the first control signal from the safety device, the safety device can implement the UCM function and prevent the car from making an unintended travel movement.

According to one embodiment, the at least one third component comprises a door drive which is configured to move a door leaf of the car door between an open and a closed configuration.

In this case, the door drive can comprise the actuator already mentioned at the outset and also the actuator controller of the car door. Since the door drive can be activated or deactivated by transmitting the second control signal from the safety device, the safety device can implement the UDM function and prevent the car door from making an unintended travel movement.

According to one embodiment, the safety device, as a filter instance, can be configured to transmit or filter out a door control signal transmitted by an elevator controller of the elevator system depending on the input signals to a door drive which is configured to move a door leaf of the car door between an open and a closed configuration.

In other words, the safety device described here can be connected, in a similar manner to a conventional UDM device, between an elevator controller and a door drive of a car door, so that door control signals generated by the elevator controller first have to pass through the safety device as activation signals before they are ultimately forwarded by the latter to the door drive or the actuator controller thereof. The safety device can therefore be used as a filter instance. To this end, the safety device can check the door control signals to be transmitted for plausibility by analyzing these door control signals taking into account information that is available thereto from the input signals transmitted thereto. Only when a door control signal appears plausible in view of the information to be derived from the input signals regarding the current conditions within the elevator system will this door control signal be transmitted as the second control signal to the third component of the elevator system used for the UDM function. In the event of lack of plausibility, however, the door control signal will be filtered out and an unintended movement of the car door thus prevented.

According to one embodiment, all components forming the safety device are integrated in a common housing so as to form a unit.

In other words, not only the signal input interface and the signal processing unit but also the control unit, including possible signal output interfaces for generating and transmitting the first control signals for implementing the UCM function and for generating and transmitting the second control signals for implementing the UDM function, are accommodated in a common housing and thus form a unitary assembly. Such a safety device designed as a unit can easily be installed and optionally wired in the elevator system.

It should be noted that some of the possible features and advantages of the invention are described herein with reference to different embodiments of the safety device on the one hand and an elevator system equipped therewith on the other hand. A person skilled in the art will recognize that the features can be suitably combined, adapted, or replaced in order to arrive at further embodiments of the invention.

Embodiments of the invention will be described below with reference to the accompanying drawing, with neither the drawing nor the description being intended to be interpreted as limiting the invention.

### DESCRIPTION OF THE DRAWINGS

FIG. 1 shows an elevator system comprising a safety device according to an embodiment of the present invention.

The drawing is merely schematic and not to scale. The same reference signs indicate the same or equivalent features.

### DETAILED DESCRIPTION

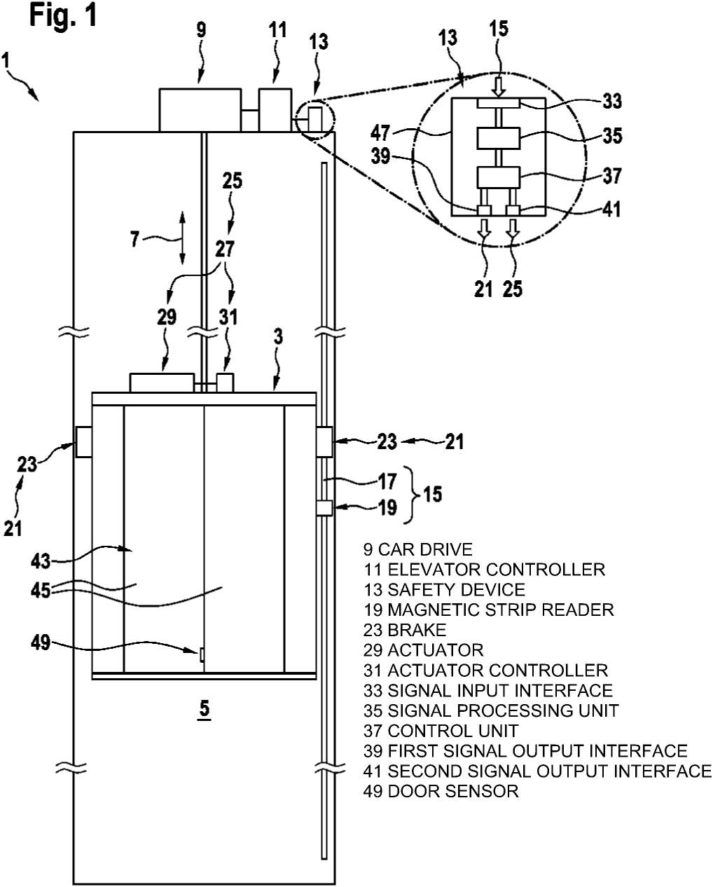

FIG. 1 shows an elevator system 1 comprising a safety device 13 according to an embodiment of the present invention.

The elevator system 1 comprises a car 3, which can be moved within an elevator shaft 5 along a vertical travel path 7. In this case, the car 3 is moved by a car drive 9, the operation of which is controlled by an elevator controller 11.

Travel movements of the car 3 can be braked or prevented by means of a brake 23 mounted on the car 3. For this purpose, the brake 23 can have, for example, brake shoes which are fixed to the car 3 and thus move along therewith. The brake shoes can interact with a braking surface which is mounted stationarily in the elevator shaft 5, such as a surface of a guide rail, and thus brake the car 3 in a controlled and efficient manner by means of friction.

The car 3 has a car door 43 in order to be able to selectively release or block access into the interior of the car 3. In the example shown, the car door 43 has two door leaves 45 which can be opened and closed by means of a door drive 27. For this purpose, the door drive 27 has an actuator 29, such as an electric motor, the operation of which can be controlled via an actuator controller 31.

In order to ensure safe operation of the elevator system 1, not only a UCM function for preventing unintended travel movements of the car 3 but also a UDM function for preventing unintended movements of the car door 43 are implemented therein. The UCM function and the UDM function are here both implemented together in the safety device 13, i.e., the safety device 13 is designed as a unit in which all components used for implementing the UCM function and the UDM function are accommodated in a common housing 47. Preferably, the safety device 13 is designed in such a way that it meets legal or normative safety regulations for implementing the UCM function. In particular, the safety device 13 is preferably designed such that it corresponds to high safety levels such as an SIL3 safety level.

For this purpose, the safety device 13 can correspond to at least one first component 15, from which it can receive input signals. The input signals can provide information regarding current conditions within the elevator system 1.

In the example shown, one of the first components 15 is implemented by means of a magnetic strip 17 and a magnetic strip reader 19. The magnetic strip 17 extends vertically along the entire travel path 7 through the elevator shaft 5. Information is stored on the magnetic strip 17 which encodes the position of the magnetic strip 17 within the elevator shaft 5 for each of a plurality of sections of the strip. The magnetic strip reader 19 can read off this information. Since the magnetic strip reader 19 is attached to the car 3, the current position of the car 3 can be determined in this way. In addition, a current speed of the car 3 can be deduced by analysis of time-dependent changes in these positions. The information regarding the current position and the current speed of the car 3 can thus be transmitted as input signals to the safety device 13. In this case, the input signals can be received by a signal input interface 33 of the safety device 13. For this purpose, the first component 15, i.e., the magnetic strip reader 19 in the example shown, can be wired to the signal input interface 33 of the safety device 13 or can wirelessly transmit its signals to the signal input interface 33.

Another of the first components 15 can be implemented, for example, in the form of a door sensor 49. The door sensor 49 can detect whether the car door 43 is completely closed and locked. Information regarding a closed state of the car door 43 can then also be transmitted to the signal input interface 33 of the safety device 13.

In addition or as an alternative to the first components 15 described by way of example, other sensors or the like can be used as first components 15 in order to obtain information regarding current conditions in the elevator system 1, in particular information relating to a position, a speed, a travel direction, an occupation, etc. of the car 3, and information relating to a current situation of the car door 43, for example its closed state, directions of movement of the door leaves 45, etc.

The received input signals can then be processed by a signal processing unit 35 in the safety device 13. The signal processing unit 35 can generate both first control signals and second control signals on the basis of these input signals.

The first and second control signals generated in this way can then be used by a control unit 37 of the safety device 13 to control a second component 21 and a third component 25 in the elevator system 1. For this purpose, the control unit 37 can transmit the first control signal to the second component 21 via a first signal output interface 39, for example, in order to thus implement the UCM function, i.e., to prevent unintended travel movements of the car 3. In addition, the control unit 37 can transmit the second control signal to the third component 25 via a second signal output interface 41, for example, in order to thus implement the UDM function, i.e., to prevent unintended movements of the car door 43.

In the example shown, the second component 21 for this purpose comprises the brake 23 on the car 3. If the safety device 13 detects, for example, on the basis of the input signals received from the door sensor 49 that the car door 43 is not completely closed and detects on the basis of the input signals received from the magnetic strip reader 19 that the car 3 is moving along the travel path 7, the safety device 13 can activate the brake 23 and in this way stop the unintended travel movement of the car 3.

In the example shown, the third component 25 comprises the door drive 27 on the car door 43. If, for example, a door control signal is to be sent from the elevator controller 11 to the car door 43, on the basis of which the car door 43 is to be opened or closed, this door control signal will not be transmitted directly to the door drive 27. Instead, the safety device 13 is connected as a filter instance between the elevator controller 11 and the door drive 27. The door control signal is first checked in the safety device 13 for plausibility. For this purpose, the safety device 13 can detect, for example, on the basis of the input signals received at the signal input interface 33, where the car 3 is currently located and whether and at which speed it is moving. Only if it can be seen on the basis of this position information and speed information that the car 3 is located, for example, either directly at a floor position or within a door zone close to the floor position and its speed is currently slowing down in a suitable manner, so that it will stop at the floor position, a door control signal, for example, that indicates an opening of the car door 43, will be considered plausible. Only in the case of such a detected plausibility will the door control signal then not be filtered by the safety device 13, but rather forwarded to the door drive 27. The actuator controller 31 of the door drive 27 can then suitably energize the actuator 29 in order to open the door leaves 45 of the car door 43.

Finally, it should be noted that terms such as “comprising,” “having,” etc. do not preclude other elements or steps and terms such as “a” or “an” do not preclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-9. (canceled)

10. A safety device for controlling safety-relevant functions in an elevator system, the safety device comprising:
an input for receiving input signals from a first component of the elevator system, wherein the input signals provide information regarding current conditions within the elevator system;
a signal processing unit receiving and processing the input signals to generate a first control signal and a second control signal both based on the input signals;
a first output connected to the signal processing unit for transmitting the first control signal to a second component of the elevator system to control the second component such that an unintended travel movement of a car of the elevator system is prevented; and
a second output connected to the signal processing unit for transmitting the second control signal to a third component of the elevator system to control the third component such that an unintended movement of a car door of the car is prevented.

11. The safety device according to claim 10 wherein the safety device further comprises:
a signal input interface at the input for receiving the input signals from the first component of the elevator system; and
a control unit connected to the signal processing unit, the first output and the second output for transmitting the first control signal and the second control signal.

12. The safety device according to claim 10 wherein the input signals indicate a current position and a current speed of the car of the elevator system.

13. The safety device according to claim 12 wherein the input signals indicate the current position and the current speed of the car for each possible position of the car along a travel path of the car and for each point in time during operation of the elevator system.

14. The safety device according to claim 10 wherein the second component comprises a brake configured to brake or prevent a travel movement of the car.

15. The safety device according to claim 10 wherein the third component comprises a door drive configured to move a door leaf of the car door between an open configuration and a closed configuration.

16. The safety device according to claim 15 wherein a door control signal transmitted by an elevator controller of the elevator system, depending on the input signals, is transmitted to the door drive as the second control signal or is filtered out.

17. The safety device according to claim 10 wherein all components forming the safety device are integrated in a common housing so as to form a unit.

18. An elevator system comprising:
a first component supplying input signals that provide information regarding current conditions within the elevator system;
a second component that in response to receiving a first control signal prevents an unintended travel movement of a car of the elevator system;
a third component that in response to receiving a second control signal prevents an unintended movement of a car door of the car; and
the safety device according to claim 10 controlling the second component and the third component by generating the first control signal and the second control signal based on the input signals from the first component.

19. A safety device for controlling safety-relevant functions in an elevator system, the safety device comprising:
an input for receiving input signals from a first component of the elevator system, wherein the input signals provide information regarding current conditions within the elevator system;
a signal input interface at the input for receiving the input signals from the first component of the elevator system;
a signal processing unit connected to the signal input interface receiving and processing the input signals to generate a first control signal and a second control signal both based on the input signals;
a control unit connected to the signal processing unit for transmitting the first control signal and the second control signal;
a first signal output interface connected to the control unit for transmitting the first control signal to a second component of the elevator system to control the second component such that an unintended travel movement of a car of the elevator system is prevented; and
a second signal output interface connected to the control unit for transmitting the second control signal to a third component of the elevator system to control the third component such that an unintended movement of a car door of the car is prevented.

20. The safety device according to claim 19 wherein the input signals indicate a current position and a current speed of the car for each possible position of the car along a travel path of the car and for each point in time during operation of the elevator system.

21. The safety device according to claim 19 wherein the second component comprises a brake configured to brake or prevent a travel movement of the car.

22. The safety device according to claim 19 wherein the third component comprises a door drive configured to move a door leaf of the car door between an open configuration and a closed configuration.

23. The safety device according to claim 22 wherein a door control signal transmitted by an elevator controller of the elevator system, depending on the input signals, is transmitted to the door drive as the second control signal or is filtered out.

24. The safety device according to claim 19 wherein all components forming the safety device are integrated in a common housing so as to form a unit.
